(19) United States
(12) Patent Application Publication
(10) Pub. No.: US 2026/0292847 A1
(43) Pub. Date: Sep. 24, 2026

(54) METHOD, DEVICE AND COMPUTER READABLE MEDIUM FOR SIDELINK COMMUNICATIONS

(71) Applicant: NEC Corporation, Tokyo (JP)

(72) Inventors: Zhaobang MIAO, Beijing (CN); Jin YANG, Beijing (CN); Gang WANG, Beijing (CN)

(73) Assignee: NEC Corporation, Tokyo (JP)

(21) Appl. No.: 18/997,987

(22) PCT Filed: Jul. 27, 2022
(86) PCT No.: PCT/CN2022/108415

§ 371 Date: Jan. 23, 2025

(51) Int. Cl. H04W 72/25; H04L 1/1867

(52) U.S. Cl. CPC H04W 72/25; H04L 1/1896

(57) ABSTRACT

Embodiments of the present disclosure relate to methods, devices and computer readable media for sidelink communications. A method implemented at a first terminal device for sidelink communications comprises: determining, at a first terminal device, whether at least one physical sidelink feedback channel (PSFCH) resource within a duration of a channel occupancy time (COT) is activated for transmission of Hybrid Automatic Repeat Request (HARQ) feedback information; and in accordance with a determination that the at least one PSFCH resource is deactivated for the transmission of the HARQ feedback information, receiving sidelink data on the at least one PSFCH resource.

### TECHNICAL FIELD

Embodiments of the present disclosure generally relate to the field of telecommunication, and in particular, to a method, device and computer readable media for sidelink communications.

### BACKGROUND

In New Radio (NR) vehicle to everything (V2X), a physical sidelink feedback channel (PSFCH) is a physical sidelink channel to support sidelink Hybrid Automatic Repeat Request (HARQ) feedback information. The PSFCH carries the HARQ feedback information over a sidelink from one terminal device which is an intended recipient of a Physical Sidelink Shared Channel (PSSCH) transmission to anther terminal device which performed the transmission.

Channel Occupancy Time (COT) sharing is supported in NR sidelink operation in unlicensed band. The COT will be interrupted because of absence of PSFCH transmission in configured or pre-configured PSFCH symbols which always exist in a sidelink resource pool.

### SUMMARY

In general, example embodiments of the present disclosure provide methods, devices and computer readable media for sidelink communications.

In a first aspect, there is provided a method implemented at a first terminal device for sidelink communications. The method comprises: determining, at a first terminal device, whether at least one PSFCH resource within a duration of a COT is activated for transmission of HARQ feedback information; and in accordance with a determination that the at least one PSFCH resource is deactivated for the transmission of the HARQ feedback information, transmitting sidelink data on the at least one PSFCH resource.

In a second aspect, there is provided a method for sidelink communications. The method comprises: determining, at a second terminal device, whether at least one PSFCH resource within a duration of a COT is activated for reception of HARQ feedback information; and in accordance with a determination that the at least one PSFCH resource is deactivated for the reception of the HARQ feedback information, receiving sidelink data on the at least one PSFCH resource.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in accordance with some embodiments of the present disclosure;

FIG. 4 illustrates an example of a PSFCH resource in time domain in accordance with some embodiments of the present disclosure;

FIG. 5 illustrates an example of mapping between a sidelink data transmission on PSSCH and a PSFCH resource in accordance with some embodiments of the present disclosure;

FIG. 6 illustrates an example of interruption of a COT in accordance with some embodiments of the present disclosure;

FIG. 7 illustrates a flowchart of an example method in accordance with some embodiments of the present disclosure;

FIGS. 8A and 8B illustrate an example of a PSFCH resource within a duration of a COT in accordance with some embodiments of the present disclosure, respectively;

FIG. 9 illustrates an example of a PSFCH resource in frequency domain and code domain within a duration of a COT in accordance with some embodiments of the present disclosure;

FIG. 10 illustrates an example of PSFCH resources within a duration of a COT and outside the duration of the COT in accordance with some embodiments of the present disclosure;

FIG. 11A illustrates an example of a PSFCH resource which comprises RBs in a starting sub-band in accordance with some embodiments of the present disclosure;

FIG. 11B illustrates an example of a PSFCH resource which comprises RBs in all of the consecutive sub-bands in accordance with some embodiments of the present disclosure;

FIG. 12 illustrates an example of a PSFCH resource in accordance with some embodiments of the present disclosure;

FIGS. 13A and 13B illustrate an example of a PSFCH resource in accordance with some embodiments of the present disclosure, respectively;

FIG. 14 illustrates a flowchart of another example method in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2(24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

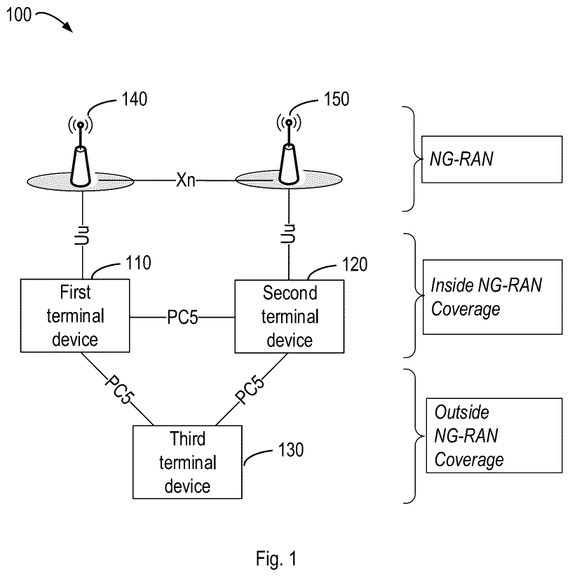

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

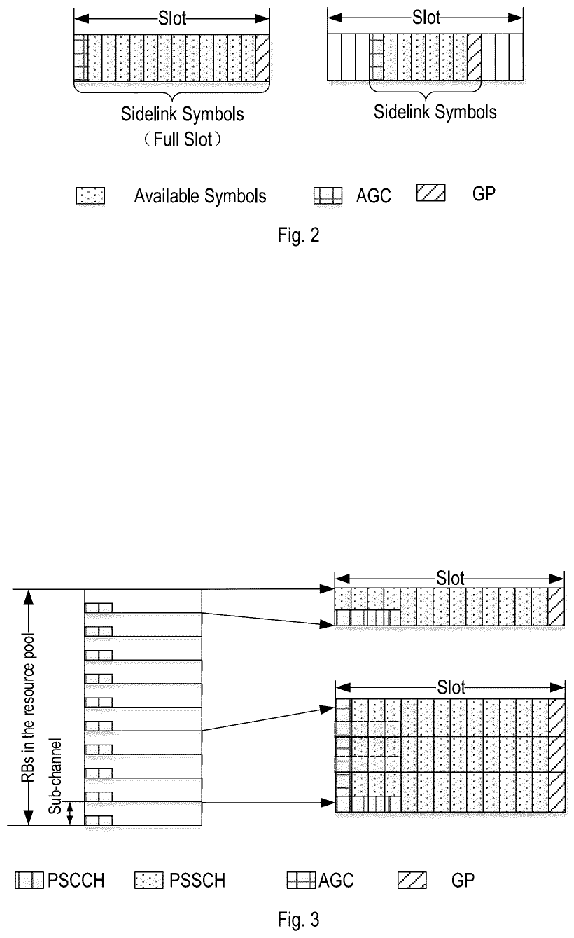

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The first terminal device 110, the second terminal device 120 and the third terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink Hybrid Automatic Repeat Request (HARQ) feedback information, a physical sidelink broadcast channel (PSBCH) resource which is used for carrying sidelink broadcast information, and a physical sidelink discovery channel (PSDCH) resource which is used for carrying a sidelink discovery signal. Hereinafter, a PSFCH resource is also referred to as a feedback channel resource or HARQ feedback opportunity.

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the first terminal device 110, the second terminal device 120 and the third terminal device 130 uses the PSSCH resource to send sidelink information, it can use one or more sub-channels to carry corresponding data information. A PSCCH resource includes t symbols in time domain, and/RBs in frequency domain. Each PSCCH channel resource is located at consecutive t symbols starting from the first symbol in the available symbols in the time domain, and located at the position of consecutive/RBs starting from the first RB in the corresponding sub-channel in the frequency domain, as shown in FIG. 3.

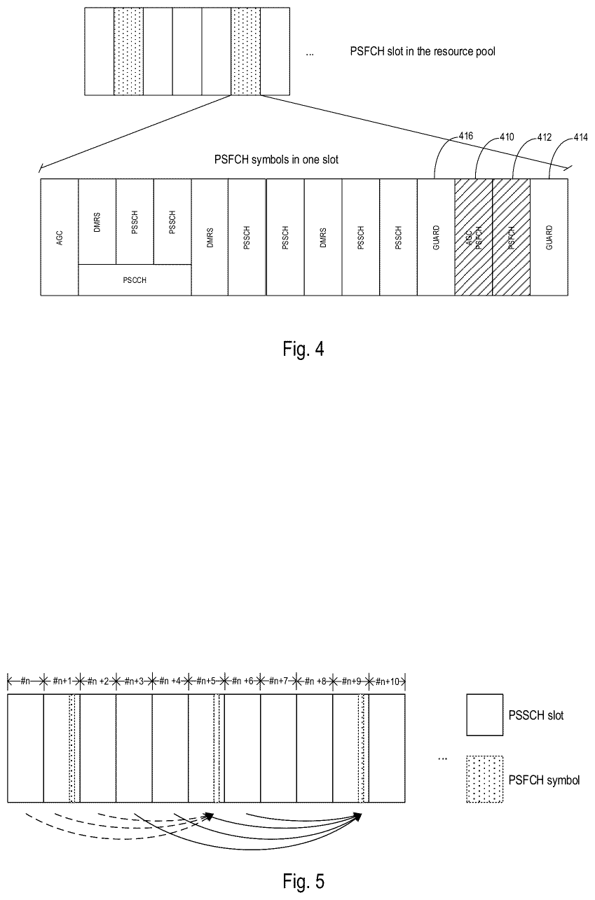

FIG. 4 illustrates an example of a PSFCH resource in time domain in accordance with some embodiments of the present disclosure. In a sidelink resource pool, PSCCH or PSSCH resources are presented in every slot and used for transmitting sidelink data. In the sidelink resource pool, whether a PSFCH resource is available may be configured or pre-configured.

In time domain, according to the configuration or pre-configuration of the sidelink resource pool, one of every N slots in the resource pool contains a PSFCH resource, N=[0,1,2,4]. In the example of FIG. 4, N=4. Hereinafter, a slot containing a PSFCH resource may be referred to as a PSFCH slot.

In time domain, a PSFCH resource may comprise at least one symbol for carrying sidelink HARQ feedback information. For example, as shown in FIG. 4, a PSFCH resource may comprise symbols 410 and 412 before the last symbol 414 of a PSFCH slot. The first one of the two symbols (for example, the symbol 410) may be used for AGC. Alternatively, a PSFCH resource may comprise the at least one symbol for carrying sidelink HARQ feedback information and at least one GP symbol associated with the at least one symbol for carrying sidelink HARQ feedback information. For example, as shown in FIG. 4, a PSFCH resource may comprise the symbols 410 and 412 and a GP symbol 416 before the symbols 410 and 412. Hereinafter, each of a symbol for carrying sidelink HARQ feedback information and a GP symbol associated with the symbol for carrying sidelink HARQ feedback information may be referred to as a PSFCH symbol.

In addition, a PSFCH resource may comprise at least one RB in frequency domain and at least one code (e.g., cyclic shift) in code domain. Furthermore, the PSFCH resource may be related to one sub-channel in one slot.

The PSFCH resource is used for carrying sidelink HARQ feedback information for a sidelink data transmission on one or more PSSCH resources. Time gaps between a PSFCH resource and a PSSCH resource are various. As an example shown in FIG. 5, one out of every four slots in the resource pool contains a PSFCH resource, i.e., a PSFCH period is equal to 4.

There is an N-to-one mapping relationship in time domain between a PSSCH resource and a PSFCH resource. For data transmission on PSSCH in slot #n, the associated HARQ feedback information should be reported in slot #n+k₀, k₀>=K₀. K₀ represents a minimum gap between a PSSCH resource and a PSFCH resource. K₀ may be configured or pre-configured through high layer. As shown in FIG. 5, K₀=3 slots. Accordingly, the HARQ feedback information associated with the PSSCH in slots #n, #n+1 and #n+2 should be reported on PSFCH in slot #n+5, and the HARQ feedback information associated with the PSSCH in slots #n+3, n+4, n+5 and n+6 should be reported on PSFCH in slot #n+9.

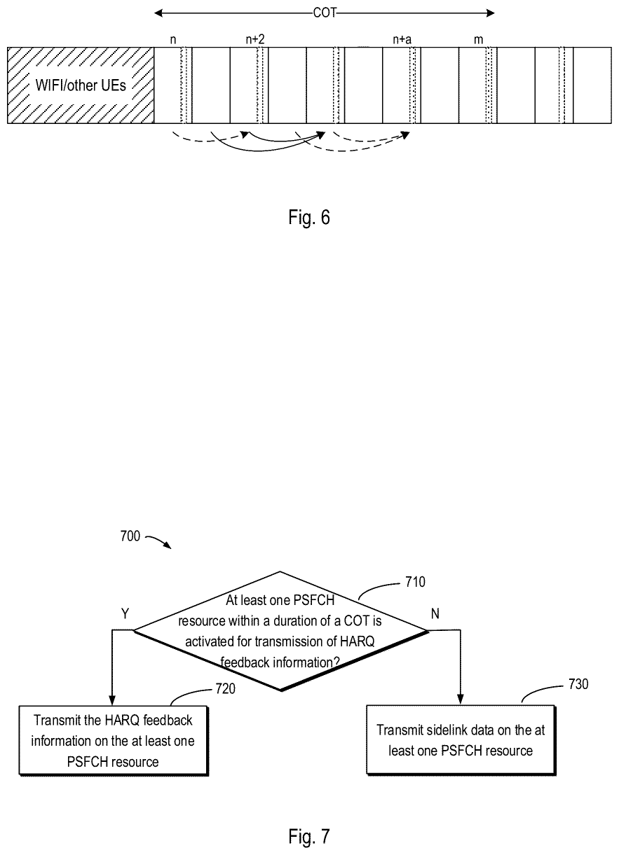

As describe above, COT sharing is supported in NR sidelink operation in unlicensed band. The COT will be interrupted because of absence of PSFCH transmission in configured or pre-configured PSFCH symbols which always exist in a sidelink resource pool. This will be described with reference to FIG. 6.

FIG. 6 illustrates an example of a sidelink COT interruption. In the example of FIG. 6, a minimum gap between a PSSCH and a PSFCH is equal to 2 (slots), and a PSFCH period is equal to 2 (slots). As shown in FIG. 6, UEs employing WIFI or other access technology may perform data transmission before slot n. For example, there may be no PSFCH transmission at beginning of COT (e.g., in slot n) due to processing time. For another example, there may be no PSFCH transmission within the COT (e.g., in slots #n+2, n+a) due to blind retransmission without HARQ-ACK on the associated PSSCH.

Embodiments of the present disclosure provide a solution for sidelink transmission so as to solve the above problems and one or more of other potential problems. According to the solution, a terminal device determines whether at least one PSFCH resource within a duration of a COT is activated for transmission of HARQ feedback information. If the at least one PSFCH resource is activated, the terminal device transmits the HARQ feedback information on the at least one PSFCH resource. If the at least one PSFCH resource is deactivated, the terminal device transmits sidelink data on the at least one PSFCH resource. In this way, sidelink COT interruption may be avoided. Hereinafter, principle of the present disclosure will be described with reference to FIGS. 7 to 15.

FIG. 7 illustrates a flowchart of an example method in accordance with some embodiments of the present disclosure. In some embodiments, the method 700 can be implemented at a terminal device, such as one of the terminal device 110, the terminal device 120 and the terminal device 130 as shown in FIG. 1. For the purpose of discussion, the method 700 will be described with reference to FIG. 1 as performed by the terminal device 110 without loss of generality.

At block 710, the terminal device 110 determines whether at least one PSFCH resource within a duration of a COT is activated for transmission of HARQ feedback information.

If the at least one PSFCH resource is activated for the transmission of HARQ feedback information, the terminal device 110 transmits, at block 720, the HARQ feedback information on the at least one PSFCH resource. On the other hand, if the at least one PSFCH resource is deactivated for the transmission of HARQ feedback information, the terminal device 110 transmits, at block 730, sidelink data on the at least one PSFCH resource. Because the terminal device 110 transmits sidelink data on the at least one PSFCH resource which is deactivated within the COT, COT interruption may be avoided.

In some embodiments, the terminal device 110 may determine whether the at least one PSFCH resource is activated for the transmission of the HARQ feedback information based on at least one of the following: a pre-configuration of sidelink resources, or SCI received from at least one second terminal device. In other words, the terminal device 110 may determine whether the at least one PSFCH resource is activated based on a combination of the pre-configuration of sidelink resources and a dynamic indication in the SCI.

In some embodiments, the SCI may comprise sharing information about the COT. The sharing information may comprise at least two of the following: a start slot of the duration of the COT, an end slot of the duration of the COT, or the duration of the COT.

In some embodiments, the at least one second terminal device transmitting the sharing information about the COT may comprise a terminal device which initiates the COT. For example, the terminal device 120 in FIG. 1 may initiate the COT and transmit the sharing information about the COT to the terminal device 110.

Alternatively, the at least one second terminal device may comprise a terminal device which inherits the COT which is initiated by another terminal device and forwards the sharing information about the COT. For example, the terminal device 130 in FIG. 1 may initiate the COT and transmit the sharing information about the COT to the terminal device 120. The terminal device 120 may inherit the COT and forward the sharing information about the COT to the terminal device 110.

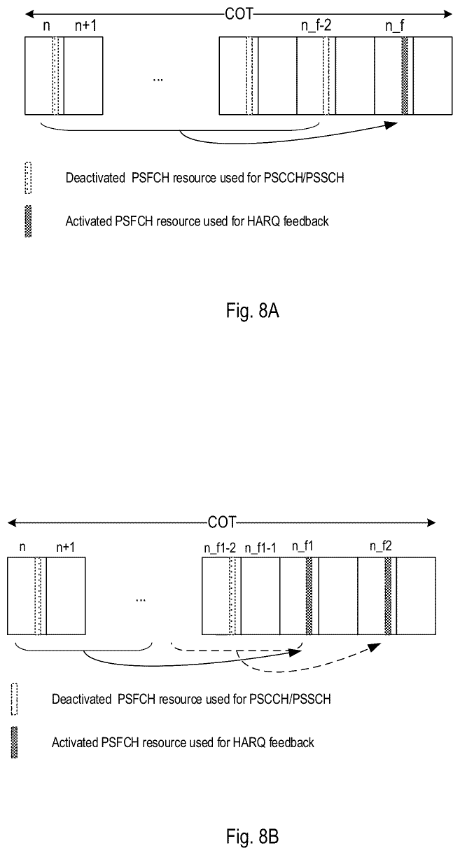

In some embodiments, the terminal device 110 may determine PSFCH slots within the duration of the COT based on the pre-configuration of sidelink resources and the sharing information about the COT. If a first PSFCH resource among the at least one PSFCH resource comprises PSFCH symbols in an end PSFCH slot among the PSFCH slots, the terminal device 110 may determine that the first PSFCH resource is activated for the transmission of the HARQ feedback information. If a second PSFCH resource among the at least one PSFCH resource comprises PSFCH symbols in a second PSFCH slot among the at least one PSFCH resource, the terminal device 110 may determine that the second PSFCH resource is deactivated for the transmission of the HARQ feedback information. The second PSFCH slot is different from the end PSFCH slot. This will be described with reference to FIG. 8A.

FIG. 8A illustrates an example of a PSFCH resource within a duration of a COT in accordance with some embodiments of the present disclosure. In the example of FIG. 8A, a minimum gap between a PSSCH and a PSFCH is equal to 2 (slots), and a PSFCH period is equal to 2 (slots).

As shown in FIG. 8A, the terminal device 110 receives sidelink data from the terminal device 120 in PSSCH reception occasions in slots n, n+1 and (n_f−2) and transmits HARQ feedback information for the sidelink data in slot n_f to the terminal device 120. The slots n, n+1, n_f−2 and n_fare in the same COT.

The terminal device 110 determines PSFCH slots periodically pre-configured per sidelink resource pool based on the pre-configuration of sidelink resources. Each of the PSFCH slots comprises PSFCH symbols.

In addition, the terminal device 110 determines periodically pre-configured PSFCH slots within the duration of the COT based on the sharing information about the COT received from the terminal device 120. For example, the sharing information about the COT may comprise a start slot of the duration of the COT and the duration of the COT. The terminal device 110 may determine periodically pre-configured PSFCH slots within the duration of the COT based on the start slot of the duration of the COT and the duration of the COT.

In turn, the terminal device 110 determines the last PSFCH slot n_f within the duration of the COT as the activated PSFCH resource in time domain. In other words, the location of the activated PSFCH resource in time domain (i.e., the last PSFCH slot n_f) within the duration of the COT is implicitly indicated by the sharing information about the COT. In addition, the terminal device 110 determines other PSFCH slots than the last PSFCH slot n_f within the duration of the COT as the deactivated PSFCH resource.

In some embodiments, the terminal device 110 may determine a second set of PSSCH reception occasions within the duration of the COT based on the pre-configuration of sidelink resources and the sharing information. If the HARQ feedback is disabled in all of the PSSCH reception occasions in the second set, the terminal device 110 may determine that the at least one PSFCH resource is deactivated for transmission of second set of HARQ feedback information for the second set of PSSCH reception occasions.

In some embodiments, the pre-configuration of sidelink resources may indicate that the number of PSFCH resources within the duration of the COT to be activated for the transmission of the HARQ feedback information is equal to 2. Alternatively, if the duration of the COT is greater than a threshold, the terminal device 110 may determine that the number of PSFCH resources within the duration of the COT to be activated is equal to 2. It shall be understood that the number of PSFCH resources may be other proper integer number.

In embodiments where the number of PSFCH resources within the duration of the COT to be activated is equal to 2, if a PSFCH resource comprises PSFCH symbols in a PSFCH slot immediately before the end PSFCH slot, the terminal device 110 may determine that the PSFCH resource also is activated for the transmission of the HARQ feedback information. This will be described with reference to FIG. 8B.

FIG. 8B illustrates an example of a PSFCH resource within a duration of a COT in accordance with some embodiments of the present disclosure. In the example of FIG. 8B, a minimum gap between a PSSCH and a PSFCH is equal to 2 (slots), and a PSFCH period is equal to 2 (slots).

As shown in FIG. 8B, the terminal device 110 receives sidelink data from the terminal device 120 in PSSCH reception occasions in slots n, n+1 and so on. The terminal device 110 transmits, in slot n_f1, HARQ feedback information for the PSSCH reception occasions in slots n, n+1 and so on to the terminal device 120.

In addition, the terminal device 110 receives sidelink data from the terminal device 120 or the terminal device 130 in PSSCH reception occasions in slots n_f1−2, n_f1−1, n_f1 and so on. The terminal device 110 transmits, in slot n_f2, HARQ feedback information for the PSSCH reception occasions in slots n_f1−2, n_f1−1, n_f1 and so on to the terminal device 120. The slots n, n+1, . . . , n_f1−2, n_f1−1, n_f1 and n_f2 are in the same COT.

Similar to the example of FIG. 8A, the terminal device 110 may determine the last PSFCH slot n_f2 within the duration of the COT as the activated PSFCH resource in time domain.

Furthermore, if the pre-configuration of sidelink resources indicates that the number of PSFCH resources within the duration of the COT to be activated is equal to 2, or if the duration of the COT is greater than a threshold, the terminal device 110 may determine that the number of PSFCH resources within the duration of the COT to be activated is equal to 2. In turn, the terminal device 110 may determine a PSFCH slot (i.e., PSFCH slot n_f1) immediately before the last PSFCH slot n_f2 as another activated PSFCH resource.

It will be understood that in the example of FIG. 8B, the locations of the activated PSFCH resources in time domain (i.e., the last two PSFCH slots) within the duration of the COT are implicitly indicated by the sharing information about the COT.

In addition, the terminal device 110 determines other PSFCH slots than the last two PSFCH slots (i.e., PSFCH slots n_f1 and n_f2) within the duration of the COT as the deactivated PSFCH resource.

In some embodiments, if a time gap between the first PSFCH resource and each of PSSCH reception occasions in a first set within the duration of the COT is greater than or equal to a minimum time gap indicated by the pre-configuration of sidelink resources, the terminal device 110 may determine that the HARQ feedback information comprises a first set of HARQ feedback information for the PSSCH reception occasions.

Consider the example of FIG. 8A. The terminal device 110 receives sidelink data from the terminal device 120 in the PSSCH reception occasions in slots n, n+1, . . . , and (n_f−2). The terminal device 110 determines the last PSFCH slot n_f within the duration of the COT as the activated PSFCH resource. A minimum time gap indicated by the pre-configuration of sidelink resources is equal to 2. A time gap between the last PSFCH slot n_f and each of PSSCH reception occasions in slots n, n+1, . . . , and (n_f−2) within the duration of the COT is greater than or equal to 2. Thus, in the last PSFCH slot n_f, the terminal device 110 transmits HARQ feedback information for the PSSCH reception occasions in slots n, n+1, . . . , and (n_f−2) to the terminal device 120.

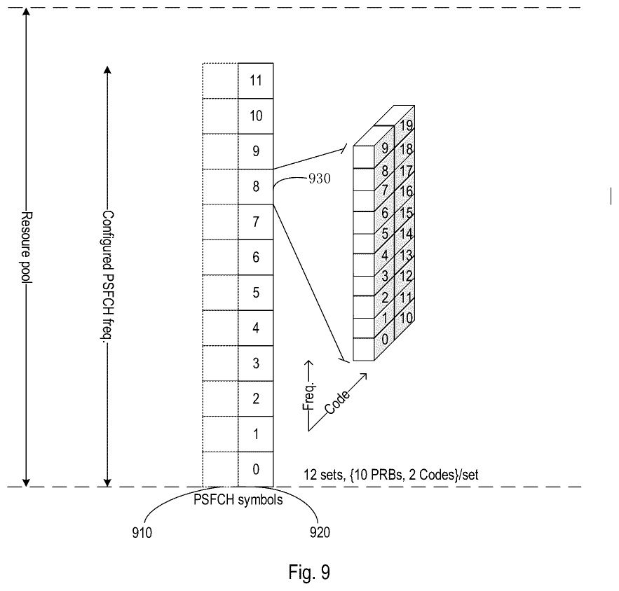

In some embodiments, the terminal device 110 may determine a frequency domain and code domain resource comprised in the first PSFCH resource based on at least one of the following: the number of the PSSCH reception occasions, a physical layer source identity of at least one second terminal device transmitting sidelink data in the PSSCH reception occasions, or an identity of the terminal device 110. This will be described with reference to FIG. 9.

FIG. 9 illustrates an example of a PSFCH resource in frequency domain and code domain within a duration of a COT in accordance with some embodiments of the present disclosure. In FIG. 9, the PSFCH resource in slot #n+9 as shown in FIG. 5 will be described by way of example.

As described with reference to FIG. 5, the HARQ feedback information associated with the PSSCH resources in slots #n+3, n+4, n+5 and n+6 may be reported on the PSFCH resource in slot #n+9. Each of the PSSCH resources in slots #n+3, n+4, n+5 and n+6 may comprises PRBs in three consecutive sub-channels.

In time domain, the PSFCH resource in slot #n+9 comprises PSFCH symbols 910 and 920 for carrying sidelink HARQ feedback information. Hereinafter, a frequency domain and code domain resource in the PSFCH symbol 920 will be described by way of example.

In frequency domain, configured PSFCH resources may comprise 120 PRBs. The 120 PRBs are divided into 12 sets, each of which is associated with a sub-channel in each of the slots #n+3, n+4, n+5 and n+6. Each of the sets comprises 10 PRBs. For example, a set 930 comprises PRBs #0 to 9.

In some embodiments, the sidelink HARQ feedback information for a PSSCH reception occasion in one sub-channel in one slot may be mapped to a Zadoff-Chu sequence. In such embodiments, the Zadoff-Chu sequence may be determined based on a value of a cyclic shift. If two values of a cyclic shift are employed, the set 930 may comprise 2 codes. In other words, the set 930 comprises 20 frequency domain and code domain resources.

The terminal device 110 may determine one of the 20 frequency domain and code domain resources based on at least one of the following: a physical layer source identity of at least one second terminal device transmitting sidelink data in the PSSCH reception occasions, or an identity of the terminal device 110.

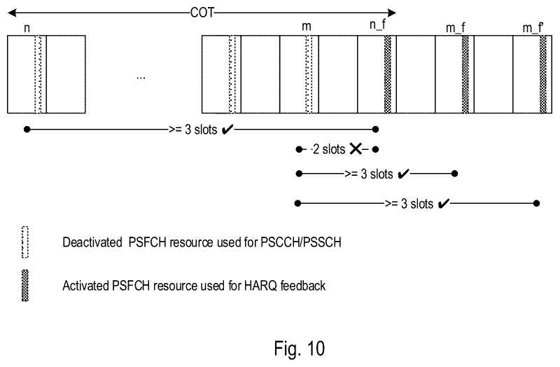

In some embodiments, if a time gap between the first PSFCH resource and a first PSSCH reception occasion within the duration of the COT is less than the minimum time gap, the terminal device 110 may determine a third PSFCH resource outside the duration of the COT based on the pre-configuration of sidelink resources. In turn, the terminal device 110 may transmit first HARQ feedback information for the first PSSCH reception occasion on the third PSFCH resource. This will be described with reference to FIG. 10.

FIG. 10 illustrates an example of PSFCH resources within a duration of a COT and outside the duration of the COT in accordance with some embodiments of the present disclosure. As shown in FIG. 10, the terminal device 110 receives sidelink data from the terminal device 120 in PSSCH reception occasions in slots n and m within the duration of the COT. The terminal device 110 determines the last PSFCH slot n_f within the duration of the COT as the activated PSFCH resource.

A minimum time gap indicated by the pre-configuration of sidelink resources is equal to 3. A time gap between the last PSFCH slot n_f and the PSSCH reception occasion in slot n is greater than 3. Thus, in the last PSFCH slot n_f, the terminal device 110 transmits HARQ feedback information for the PSSCH reception occasion in slot n to the terminal device 120.

A time gap between the last PSFCH slot n_f and the PSSCH reception occasion in slot m is equal to 2, which is less than 3. Thus, in the last PSFCH slot n_f, the terminal device 110 does not transmit HARQ feedback information for the PSSCH reception occasion in slot m to the terminal device 120.

In order to transmit the HARQ feedback information for the PSSCH reception occasion in slot m, the terminal device 110 determines a PSFCH resource outside the duration of the COT based on the pre-configuration of sidelink resources. For example, the terminal device 110 determines a PSFCH resource in slot m_f outside the duration of the COT. If a channel access (CA) procedure before the slot m_f succeeds, the terminal device 110 transmits, in the slot m_f, the HARQ feedback information for the PSSCH reception occasion in slot m. If the CA procedure before the slot m_f fails and multiple PSFCH transmission opportunities are enabled, the terminal device 110 may try to access channel before slot m_f.

In some embodiments, if a priority of sidelink data is higher than a threshold (priority values in SCI<threshold) and HARQ feedback is enabled for the sidelink data, the sidelink data may be transmitted on a first PSSCH resource within the duration of the COT. A time gap between the first PSSCH resource and the first PSFCH resource is greater than the minimum time gap indicated by the pre-configuration of sidelink resources.

For example, if a priority of sidelink data to be transmitted by the terminal device 120 is higher than a threshold and HARQ feedback is enabled for the sidelink data, the terminal device 120 may select the first PSSCH resource within the duration of the COT for transmission of the sidelink data. The time gap between the first PSSCH resource and the first PSFCH resource is greater than the minimum time gap. In other words, the terminal device 120 with higher priority traffic and HARQ-ACK enabling may attempt to select resources within the COT as early as possible. This may ensure that HARQ feedback information for higher priority traffic could be transmitted within the COT.

In some embodiments, if HARQ feedback is disabled for sidelink data, the sidelink data may be transmitted on a second PSSCH resource within the duration of the COT. A time gap between the second PSSCH resource and the first PSFCH resource is less than a minimum time gap indicated by the pre-configuration of sidelink resources.

For example, if HARQ feedback is disabled for sidelink data to be transmitted by the terminal device 130, the terminal device 130 may select the second PSSCH resource within the duration of the COT for transmission of the sidelink data. The time gap between the second PSSCH resource and the first PSFCH resource is less than the minimum time gap. In other words, the terminal device 130 with HARQ-ACK disabling may select a resource within the COT as late as possible.

In some embodiments, in frequency domain, there may be wide band operation. For example, there may be an operation in a combination of four sub-bands, listen before talk (LBT) bandwidths (BWs), or RB sets. We need to consider a sub-band index when mapping PSSCH to PSFCH.

In such embodiments, the terminal device 110 may receive sidelink data in consecutive sub-bands associated with a PSSCH reception occasion. If the first PSFCH resource is activated for the transmission of the HARQ feedback information for the PSSCH reception occasion, the terminal device 110 may determine that the first PSFCH resource comprises RBs in at least one of the consecutive sub-bands.

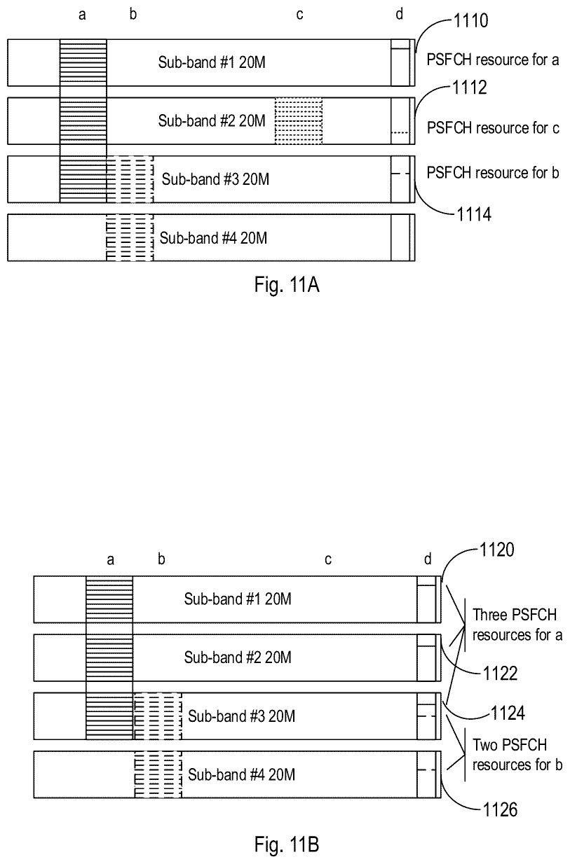

In some embodiments, the first PSFCH resource may comprise RBs in a starting one of the consecutive sub-bands. This will be described with reference to FIG. 11A.

FIG. 11A illustrates an example of a PSFCH resource which comprises RBs in a starting sub-band in accordance with some embodiments of the present disclosure. As shown in FIG. 11A, the terminal device 110 receives sidelink data in a sub-band #1, a sub-band #2 and a sub-band #3 associated with a PSSCH reception occasion in slot #a. The terminal device 110 also receives sidelink data in the sub-band #3 and a sub-band #4 associated with a PSSCH reception occasion in slot #b. The terminal device 110 also receives sidelink data in the sub-band #2 associated with a PSSCH reception occasion in slot #c. PSFCH resources comprises RBs in slot #d.

A PSFCH resource 1110 for transmission of HARQ feedback information for the PSSCH reception occasion in slot #a comprises RBs in a starting one of the consecutive sub-bands #1, #2 and #3 (i.e., the sub-band #1).

A PSFCH resource 1112 for transmission of HARQ feedback information for the PSSCH reception occasion in slot #c comprises RBs in the sub-band #2.

A PSFCH resource 1114 for transmission of HARQ feedback information for the PSSCH reception occasion in slot #b comprises RBs in a starting one of the consecutive sub-bands #3 and #4 (i.e., the sub-band #3).

In some embodiments, the first PSFCH resource may comprise RBs in all of the consecutive sub-bands. In such embodiments, if a channel access procedure on a first sub-band among the consecutive sub-bands succeeds, the terminal device 110 transmits HARQ feedback information for the sidelink data on the first sub-band. Alternatively, if channel access procedures on all of the consecutive sub-bands succeed, the terminal device 110 transmits the HARQ feedback information for the sidelink data on all of the consecutive sub-bands. This will be described with reference to FIG. 11B.

FIG. 11B illustrates an example of a PSFCH resource which comprises RBs in all of the consecutive sub-bands in accordance with some embodiments of the present disclosure. Similar to the example in FIG. 11A, the terminal device 110 receives sidelink data in the sub-bands #1, #2 and #3 associated with the PSSCH reception occasion in slot #a. The terminal device 110 also receives sidelink data in the sub-bands #3 and #4 associated with the PSSCH reception occasion in slot #b.

PSFCH resources 1120, 1122 and 1124 for transmission of HARQ feedback information for the PSSCH reception occasion in slot #a comprise RBs in all of the consecutive sub-bands #1, #2 and #3. If a channel access procedure on one sub-band, such as the sub-band #2, the terminal device 110 transmits HARQ feedback information for the sidelink data on the sub-band #2. Alternatively, if channel access procedures on all of the consecutive sub-bands #1, #2 and #3 succeed, the terminal device 110 transmits the HARQ feedback information for the sidelink data on all of the consecutive sub-bands #1, #2 and #3.

PSFCH resources 1124 and 1126 for transmission of HARQ feedback information for the PSSCH reception occasion in slot #b comprises RBs in all of the consecutive sub-bands #3 and #4. If a channel access procedure on one sub-band, such as the sub-band #3, the terminal device 110 transmits HARQ feedback information for the sidelink data on the sub-band #3. Alternatively, if channel access procedures on all of the consecutive sub-bands #3 and #4 succeed, the terminal device 110 transmits the HARQ feedback information for the sidelink data on all of the consecutive sub-bands #3 and #4.

In the examples in FIGS. 11A and 11B, low complexity may be achieved and legacy principle may be reused.

In some embodiments, the activated PSFCH resource may be explicitly indicated by SCI to enable a PSFCH resource among pre-configured PSFCH slot.

In such embodiments, the terminal device 110 may determine, based on the pre-configuration of sidelink resources, a third set of PSSCH reception occasions within the duration of the COT. The terminal device 110 may determine, based on an indication in the SCI received in at least one of the PSSCH reception occasions in the third set, that a fourth PSFCH resource among the at least one PSFCH resource is activated for transmission of fourth HARQ feedback information for the at least one of the PSSCH reception occasions.

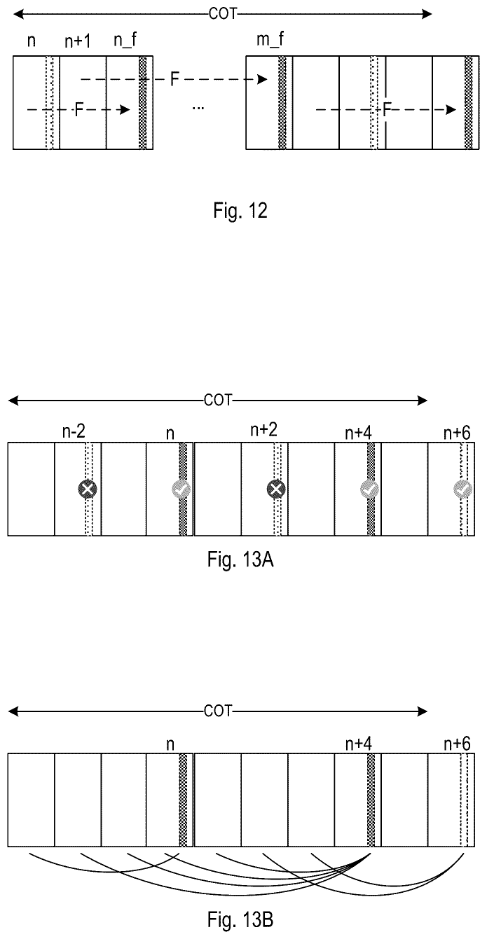

In such embodiments, the SCI may comprise a field F comprising the indication. This will be described with reference to FIG. 12.

FIG. 12 illustrates an example of a PSFCH resource in accordance with some embodiments of the present disclosure. As shown in FIG. 12, for example, the terminal device 110 determines, based on the pre-configuration of sidelink resources, a third set of PSSCH reception occasions within the duration of the COT. The third set comprises a PSSCH reception occasion in slot n. SCI received in the PSSCH reception occasion in slot n comprises a field F. A value of the field F indicates that a PSFCH resource in slot n_f is activated for transmission of HARQ feedback information for the PSSCH reception occasion in slot n.

For another example, the terminal device 110 determines, based on the pre-configuration of sidelink resources, a fourth set of PSSCH reception occasions within the duration of the COT. The fourth set comprises a PSSCH reception occasion in slot n+1. SCI received in the PSSCH reception occasion in slot n+1 comprises a field F. A value of the field F indicates that a PSFCH resource in slot m_f is activated for transmission of HARQ feedback information for the PSSCH reception occasion in slot n+1.

It will be understood that in the example of FIG. 12, for each PSFCH slot, the terminal device 110 should decode other SCI in a slot set of PSSCH reception occasions which may associated with this PSFCH slot so as to calculate how many PSSCH slots are associated with the PSFSH slot. In turn, the terminal device 110 may determine whether there is an activated PSFCH and determine the exact PSFCH resource location in the slot. The slot set contains the slots at least a minimum gap before the PSFCH slot (e.g., slot m_f) and within the COT.

In addition, in such embodiments, the terminal device 120 transmitting the SCI may determine the value of the field F according to high layer packet delay budget (PDB) requirement or high layer indication.

In some embodiments, the pre-configuration of sidelink resources is activated for the COT and indicates at least one of the following: an offset of a start PSFCH resource within the duration of the COT to the start slot of the duration of the COT or a period of PSFCH resources within the duration of the COT. The offset is greater than a minimum time gap between a PSFCH resource and a PSSCH reception occasion within the duration of the COT. In other words, in such embodiments, for a BWP or a sidelink resource pool, a first set of PSFCH slots are periodically configured which could reuse R16 NR SL scheme. In addition, for a COT, a second set of PSFCH slots is pre-configured per BWP or sidelink resource pool to overwrite the first set PSFCH slots within the COT by at least one of the offset or a period of PSFCH resources within the duration of the COT. This will be described with reference to FIGS. 13A and 13B.

FIGS. 13A and 13B illustrate an example of a PSFCH resource in accordance with some embodiments of the present disclosure, respectively. As shown in FIG. 13A, the terminal device 110 determines a first set of PSFCH slots based on a first pre-configuration of sidelink resources. The first set of PSFCH slots comprises slots n−2, n, n+2, n+4 and n+6. The terminal device 110 determines a second set of PSFCH slots based on a second pre-configuration of sidelink resources within the COT duration. The second set of PSFCH slots comprises slots n and n+4.

The second pre-configuration of sidelink resources indicates an offset of a start PSFCH resource within the duration of the COT to the start slot of the duration of the COT. The offset is greater than a minimum time gap between a PSFCH resource and a PSSCH reception occasion within the duration of the COT.

As shown in FIG. 13B, the offset is equal to 4 and the minimum time gap is equal to 3. In addition, the second pre-configuration of sidelink resources indicates a period of PSFCH resources within the duration of the COT. In this example, the period of PSFCH resources is equal to 4. It may be understood that the second set of PSFCH slots overwrites the first set of PSFCH slots within the COT duration, PSFCH resources in slots n, n+4, n+6 are activated as shown in FIG. 13B. The activated PSFCH resource is determined as the earliest PSFCH slot which is at least minimum time gap after the PSSCH among the final PSFCH slots.

In the examples of FIGS. 13A and 13B, to let other terminal devices know the PSFCH location within the COT, the COT information (at least the start, the end or the duration of the COT) should be indicated in sharing information of the COT.

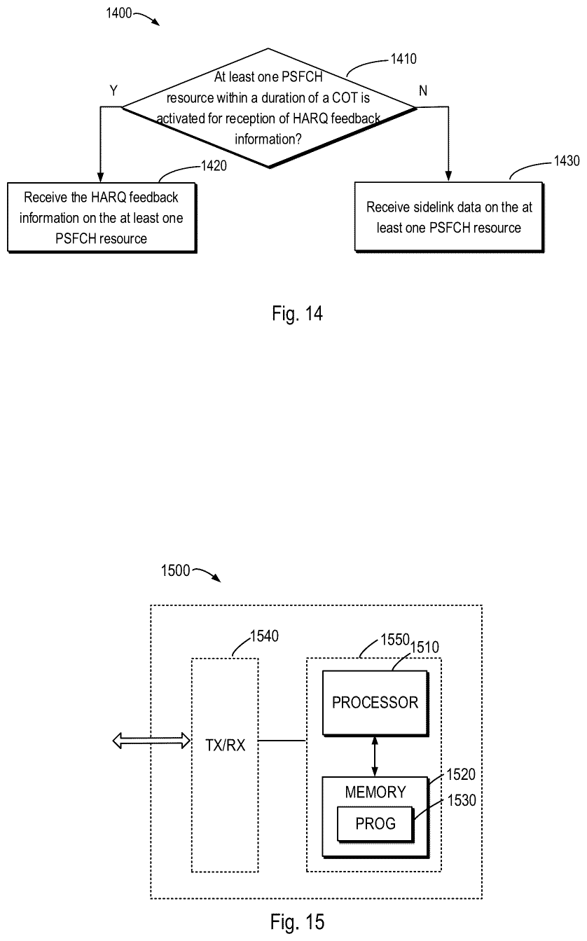

FIG. 14 illustrates a flowchart of an example method in accordance with some embodiments of the present disclosure. In some embodiments, the method 1400 can be implemented at a terminal device, such as one of the terminal device 110, the terminal device 120 and the terminal device 130 as shown in FIG. 1. For the purpose of discussion, the method 1400 will be described with reference to FIG. 1 as performed by the terminal device 120 without loss of generality.

At block 1410, the terminal device 120 determines whether at least one PSFCH resource within a duration of a COT is activated for reception of HARQ feedback information.

If the at least one PSFCH resource is activated for the reception of HARQ feedback information, the terminal device 120 receives, at block 1420, the HARQ feedback information on the at least one PSFCH resource. On the other hand, if the at least one PSFCH resource is deactivated for the reception of HARQ feedback information, the terminal device 120 receives, at block 1430, sidelink data on the at least one PSFCH resource. Because the terminal device 120 receives sidelink data on the at least one PSFCH resource which is deactivated within the COT, COT interruption may be avoided.

In some embodiments, the method 1400 further comprises: determining whether the at least one PSFCH resource is activated for the reception of the HARQ feedback information based on at least one of the following: a pre-configuration of sidelink resources, or SCI to be transmitted to a first terminal device.

In some embodiments, the SCI comprises sharing information about the COT, and the sharing information comprises at least two of the following: a start slot of the duration of the COT, an end slot of the duration of the COT, or the duration of the COT.

In some embodiments, determining whether the at least one PSFCH resource is activated for the reception of the HARQ feedback information comprises: determining PSFCH slots within the duration of the COT based on the pre-configuration of sidelink resources and the sharing information about the COT; and in accordance with a determination that a first PSFCH resource among the at least one PSFCH resource comprises PSFCH symbols in an end PSFCH slot among the PSFCH slots, determining that the first PSFCH resource is activated for the reception of the HARQ feedback information.

In some embodiments, the method 1400 further comprises: in accordance with a determination that a second PSFCH resource among the at least one PSFCH resource comprises PSFCH symbols in a second PSFCH slot among the at least one PSFCH resource, determining that the second PSFCH resource is deactivated for the reception of the HARQ feedback information, the second PSFCH slot being different from the end PSFCH slot.

In some embodiments, the method 1400 further comprises: in accordance with a determination that a time gap between the first PSFCH resource and each of PSSCH reception occasions in a first set within the duration of the COT is greater than a minimum time gap indicated by the pre-configuration of sidelink resources, determining that the HARQ feedback information comprises a first set of HARQ feedback information for the PSSCH reception occasions.

In some embodiments, the method 1400 further comprises: determining a frequency domain and code domain resource comprised in the first PSFCH resource based on at least one of the following: the number of the PSSCH reception occasions, a physical layer source identity of the second terminal device transmitting sidelink data in the PSSCH reception occasions, or an identity of the first terminal device.

In some embodiments, the method 1400 further comprises: in accordance with a determination that a time gap between the first PSFCH resource and a first PSSCH reception occasion in the first set is less than the minimum time gap, determining a third PSFCH resource outside the duration of the COT based on the pre-configuration of sidelink resources; and receiving first HARQ feedback information for the first PSSCH reception occasion on the third PSFCH resource.

In some embodiments, the pre-configuration of sidelink resources indicates that the number of PSFCH resources within the duration of the COT to be activated for the reception of the HARQ feedback information is equal to 2; or in accordance with a determination that the duration of the COT is greater than a threshold, determining the number of PSFCH resources within the duration of the COT to be activated is equal to 2.

In some embodiments, determining whether the at least one PSFCH resource is activated for the reception of the HARQ feedback information further comprises: in accordance with a determination that a fourth PSFCH resource among the at least one PSFCH resource comprises PSFCH symbols in a PSFCH slot immediately before the end PSFCH slot, determining the fourth PSFCH resource is activated for the reception of the HARQ feedback information.

In some embodiments, determining whether the at least one PSFCH resource is activated for the reception of the HARQ feedback information comprises: determining a second set of PSSCH reception occasions within the duration of the COT based on the pre-configuration of sidelink resources and the sharing information; and in accordance with a determination that the HARQ feedback is disabled in all of the PSSCH reception occasions in the second set, determining that the at least one PSFCH resource is deactivated for reception of second set of HARQ feedback information for the second set of PSSCH reception occasions.

In some embodiments, the method 1400 further comprises: transmitting sidelink data in consecutive sub-bands associated with a second PSSCH reception occasion; and in accordance with a determination that the first PSFCH resource is activated for the reception of the HARQ feedback information, determining that the first PSFCH resource comprises Resource Blocks (RBs) in at least one of the consecutive sub-bands.

In some embodiments, the first PSFCH resource comprises RBs in a starting one of the consecutive sub-bands.

In some embodiments, the first PSFCH resource comprises RBs in all of the consecutive sub-bands.

In some embodiments, receiving the HARQ feedback information comprises: in response to a success of a channel access procedure on a first sub-band among the consecutive sub-bands, receiving third HARQ feedback information for the sidelink data on the first sub-band; or in response to a success of channel access procedures on all of the consecutive sub-bands, receiving the third HARQ feedback information for the sidelink data on all of the consecutive sub-bands.

In some embodiments, determining whether the at least one PSFCH resource is activated for the reception of the HARQ feedback information comprises: determining, based on the pre-configuration of sidelink resources, a third set of PSSCH reception occasions within the duration of the COT; and determining, based on an indication in the SCI transmitted in at least one of the PSSCH reception occasions in the third set, that a fourth PSFCH resource among the at least one PSFCH resource is activated for reception of fourth HARQ feedback information for the at least one of the PSSCH reception occasions.

In some embodiments, the pre-configuration of sidelink resources is activated for the COT and indicates at least one of the following: an offset of a start PSFCH resource within the duration of the COT to the start slot of the duration of the COT, the offset being greater than a minimum time gap between a PSFCH resource and a PSSCH reception occasion within the duration of the COT, or a period of PSFCH resources within the duration of the COT.

In some embodiments, the method 1400 further comprises: in accordance with a determination that a priority of sidelink data is higher than a threshold and HARQ feedback is enabled for the sidelink data, transmitting the sidelink data on a first PSSCH resource within the duration of the COT, a time gap between the first PSSCH resource and the first PSFCH resource being greater than a minimum time gap indicated by the pre-configuration of sidelink resources.

In some embodiments, the method 1400 further comprises: in accordance with a determination that HARQ feedback is disabled for sidelink data, transmitting the sidelink data on a second Physical Sidelink Shared Channel (PSSCH) resource within the duration of the COT, a time gap between the second PSSCH resource and the first PSFCH resource being less than a minimum time gap indicated by the pre-configuration of sidelink resources.

FIG. 15 is a simplified block diagram of a device 1500 that is suitable for implementing some embodiments of the present disclosure. The device 1500 can be considered as a further example embodiment of one of the terminal devices 110, 120 and 130, or one of the network devices 140 and 150 as shown in FIG. 1. Accordingly, the device 1500 can be implemented at or as at least a part of one of the terminal devices 110, 120 and 130, or one of the network devices 140 and 150.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 1 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

1-22. (canceled)

23. A method performed by a first terminal device, comprising:
receiving a physical sidelink shared channel (PSSCH); and
determining, for a physical sidelink feedback channel (PSFCH) transmission occasion, PSFCH resources for a PSFCH transmission with hybrid automatic repeat request (HARQ) feedback information,
wherein resource blocks (RBs) for the PSFCH resources are within a RB set with smallest index of the PSSCH, or the RBs for the PSFCH resources are over all RB sets including resources for the PSSCH; and
transmitting the PSFCH transmission with the HARQ feedback information in response to reception of the PSSCH.

24. The method of claim 23, wherein transmitting the PSFCH transmission comprising: attempting to transmit the PSFCH transmission in a slot only when the first terminal device fails to transmit the PSFCH transmission associated with the PSSCH in all previous slots for the PSFCH transmission within a number of slots for PSFCH transmission occasions.

25. A method performed by a second terminal device, comprising:
transmitting a physical sidelink shared channel (PSSCH); and
determining, for a physical sidelink feedback channel (PSFCH) transmission occasion, PSFCH resources for a PSFCH transmission with hybrid automatic repeat request (HARQ) feedback information,
wherein resource blocks (RBs) for the PSFCH resources are within a RB set with smallest index of the PSSCH, or the RBs for the PSFCH resources are over all RB sets including resources for the PSSCH; and
receiving the PSFCH transmission with the HARQ feedback information in response to transmission of the PSSCH.

26. The method of claim 25, wherein receiving the PSFCH transmission comprising: receiving the PSFCH transmission within a number of slots for PSFCH transmission occasions.

27. A first terminal device, comprising a processor configured to:
receive a physical sidelink shared channel (PSSCH); and
determine, for a physical sidelink feedback channel (PSFCH) transmission occasion, PSFCH resources for a PSFCH transmission with hybrid automatic repeat request (HARQ) feedback information,
wherein resource blocks (RBs) for the PSFCH resources are within a RB set with smallest index of the PSSCH, or the RBs for the PSFCH resources are over all RB sets including resources for the PSSCH; and
transmit the PSFCH transmission with the HARQ feedback information in response to reception of the PSSCH.

28. The first terminal device of claim 27, wherein the processor is configured to transmit the PSFCH transmission by attempting to transmit the PSFCH transmission in a slot only when the terminal device fails to transmit the PSFCH transmission associated with the PSSCH in all previous slots for the PSFCH transmission within a number of slots for PSFCH transmission occasions.
